(19) United States
(12) Patent Application Publication
(10) Pub. No.: US 2025/0261084 A1
(43) Pub. Date: Aug. 14, 2025

(54) ELECTRONIC DEVICE USING BIG DATA-BASED NEIGHBOR CELL INFORMATION, AND OPERATING METHOD THEREOF

(71) Applicant: Samsung Electronics Co., Ltd., Suwon-si (KR)

(72) Inventors: Kyungwon LEE, Suwon-si (KR); Dongha NAM, Suwon-si (KR); Sanghyun LEE, Suwon-si (KR)

(21) Appl. No.: 19/170,720

(22) Filed: Apr. 4, 2025

Related U.S. Application Data
(63) Continuation of application No. PCT/KR2023/015255, filed on Oct. 4, 2023.

(30) Foreign Application Priority Data
Oct. 4, 2022 (KR) 10-2022-0126163
Oct. 11, 2022 (KR) 10-2022-0129668

(51) Int. Cl. H04W 48/02; H04W 8/18; H04W 8/22; H04W 76/15

(52) U.S. Cl. CPC H04W 48/02; H04W 8/183; H04W 8/22; H04W 76/15

(57) ABSTRACT

An electronic device is provided. The electronic device includes memory, comprising one or more storage media, storing one or more computer programs, and one or more processors communicatively coupled to the memory, wherein the one or more computer programs include computer-executable instructions that, when executed by the one or more processors individually or collectively, cause the electronic device to identify an attach failure rate information associated with a first cell, identify whether the attach failure rate satisfies a designated barring condition, based on identifying that the attach failure rate satisfies the designated barring condition, adjust a UE capability of the electronic device by decreasing the size of the UE capability of the electronic device, transmit, to a second cell, the adjusted UE capability of the electronic device.

### CROSS-REFERENCE TO RELATED APPLICATION(S)

This application is a continuation application, claiming priority under 35 U.S.C. § 365 (c), of an International application No. PCT/KR2023/015255, filed on Oct. 4, 2023, which is based on and claims the benefit of a Korean patent application number 10-2022-0126163, filed on Oct. 4, 2022, in the Korean Intellectual Property Office, and of a Korean patent application number 10-2022-0129668, filed on Oct. 11, 2022, in the Korean Intellectual Property Office, the disclosure of each of which is incorporated by reference herein in its entirety.

### BACKGROUND

### 1. Field

The disclosure relates to an electronic device using neighbor cell information and an operation method thereof.

### 2. Description of Related Art

An electronic device may receive information from a network (e.g., base station or cell). The electronic device may perform, based on the received information, a radio access network (RAN)-associated operation.

For example, the electronic device may receive information associated with a neighbor cell from the network. The electronic device may perform, based on the information associated with a neighbor cell, at least one operation for cell reselection. Based on the information associated with the neighbor cell, the electronic device may perform at least one operation for handover. Accordingly, the RAN-associated operation may be performed based on the information provided from the network.

The electronic device may measure at least one information associated with an electric field. A measurement result may be provided to a server for managing the quality of the network. The server may collect a measurement result (also referred to as big data) from a plurality of electronic devices, and thus an electric field map may be generated.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device using neighbor cell information and an operation method thereof.

Additional aspects will be set forth in part in the description which follows and, in part, will be apparent from the description, or may be learned by practice of the presented embodiments.

In accordance with an aspect of the disclosure, an electronic device is provided. The electronic device includes memory, comprising one or more storage media, storing one or more computer programs, and one or more processors communicatively coupled to the memory, wherein the one or more computer programs include computer-executable instructions that, when executed by one or more processors individually or collectively, cause the electronic device to identify an attach failure rate information associated with a first cell, identify whether the attach failure rate satisfies a designated barring condition, based on identifying that the attach failure rate satisfies the designated barring condition, adjust a UE capability of the electronic device by decreasing the size of the UE capability of the electronic device, transmit, to a second cell, the adjusted UE capability of the electronic device.

In accordance with another aspect of the disclosure, a method performed by an electronic device is provided. The method includes identifying an attach failure rate associated with a first cell, identifying whether the attach failure rate satisfies a designated barring condition, based on identifying that the attach failure rate satisfies the designated barring condition, adjusting a UE capability of the electronic device by decreasing the size of the UE capability of the electronic device, and transmitting, to a second cell, the adjusted UE capability of the electronic device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying an attach failure rate associated with a first cell, identifying whether the attach failure rate satisfies a designated barring condition, based on identifying that the attach failure rate satisfies the designated barring condition, adjusting a UE capability of the electronic device by decreasing the size of the UE capability of the electronic device, and transmitting, to a second cell, the adjusted UE capability of the electronic device.

In accordance with another aspect of the disclosure, an electronic device is provided. The electronic device includes memory, comprising one or more storage media, storing one or more computer programs, and one or more processors communicatively coupled to the memory, wherein the one or more computer programs include computer-executable instructions that, when executed by one or more processors individually or collectively, cause the electronic device to transmit information associated with a first cell to a server, receive, from the server, information on at least one cell determined based on the information associated with the first cell, based on the information on the at least one cell, identify whether an error occurs in a second cell among the at least one cell, based on identifying that an error occurs in the second cell, transmit, to the second cell, at least a portion of a UE capability of the electronic device by adjusting the at least a portion of the UE capability of the electronic device in case that the electronic device moves to the second cell, and based on identifying that an error does not occur in the second cell, transmit a UE capability pre-stored in the electronic device to the second cell in case that the electronic device moves to the second cell.

In accordance with another aspect of the disclosure, an operation method of an electronic device is provided. The operation method includes transmitting information associated with a first cell to a server. The operation method of the electronic device includes receiving, from the server, information on at least one cell determined based on the information associated with the first cell. The operation method of the electronic device includes, based on the information on the at least one cell, identifying whether an error occurs in a second cell among the at least one cell. The operation method of the electronic device includes, based on identifying that an error occurs in the second cell, transmitting, to the second cell, at least a portion of a UE capability of the electronic device by adjusting the at least a portion of the UE capability of the electronic device in case that the electronic device moves to the second cell. The operation method of the electronic device includes, based on identifying that an error does not occur in the second cell, transmitting a UE capability pre-stored in the electronic device to the second cell in case that the electronic device moves to the second cell.

In accordance with another aspect of the disclosure, a computer-readable storage medium storing at least one instruction is provided. The at least one instruction, when executed by at least one processor of an electronic device, causes the electronic device to perform at least one operation. The at least one operation includes receiving, from the server, information on at least one cell determined based on the information associated with the first cell. The at least one operation includes, based on the information on the at least one cell, identifying whether an error occurs in a second cell among the at least one cell. The at least one operation includes, based on identifying that an error occurs in the second cell, transmitting, to the second cell, at least a portion of a UE capability of the electronic device by adjusting the at least a portion of the UE capability of the electronic device in case that the electronic device moves to the second cell. The at least one operation includes, based on identifying that an error does not occur in the second cell, transmitting a UE capability pre-stored in the electronic device to the second cell in case that the electronic device moves to the second cell.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2A is a block diagram of an electronic device for supporting legacy network communication and fifth generation (5G) network communication according to an embodiment of the disclosure;

FIG. 2B is a block diagram of an electronic device for supporting legacy network communication and 5G network communication according to an embodiment of the disclosure;

FIG. 3 is a diagram illustrating an example of an electric field map according to an embodiment of the disclosure;

FIG. 4 is a flowchart illustrating an operation method of an electronic device and a server according to an embodiment of the disclosure;

FIG. 5A is a flowchart illustrating an operation method of an electronic device according to an embodiment of the disclosure;

FIG. 5B is a flowchart illustrating an operation method of an electronic device according to an embodiment of the disclosure;

FIG. 6A is a flowchart illustrating an operation method of an electronic device according to an embodiment of the disclosure;

FIG. 6B is a flowchart illustrating an operation method of an electronic device according to an embodiment of the disclosure;

FIG. 7 is a flowchart illustrating an operation method of an electronic device according to an embodiment of the disclosure;

FIG. 8 is a flowchart illustrating an operation method of an electronic device according to an embodiment of the disclosure; and

FIG. 9 is a flowchart illustrating an operation method of an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

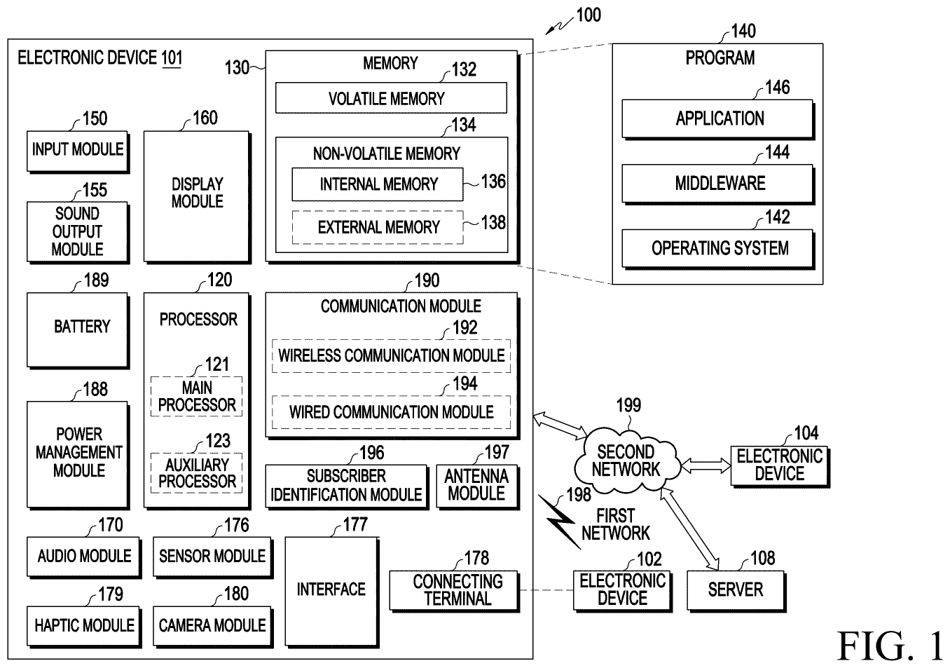

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

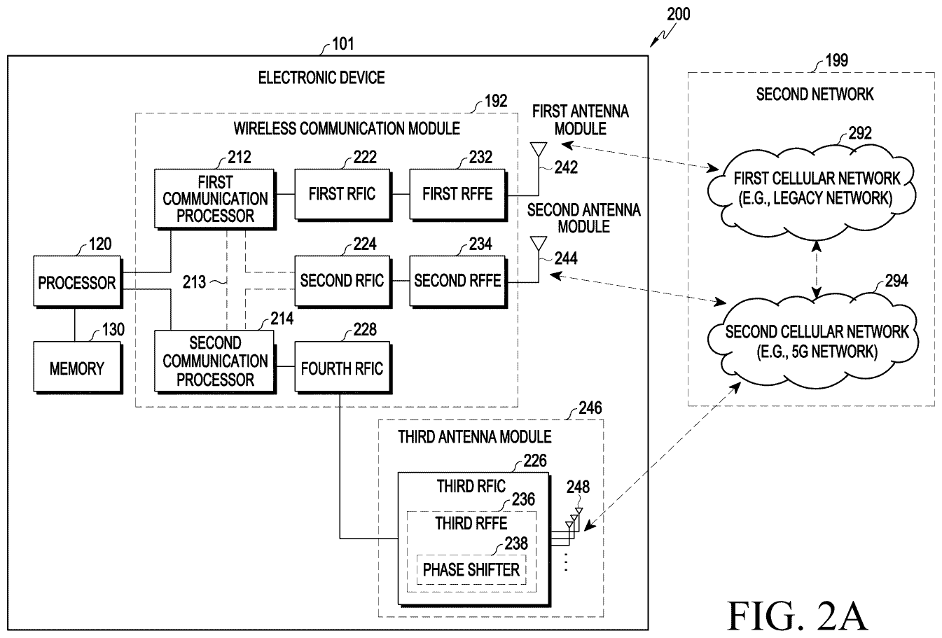

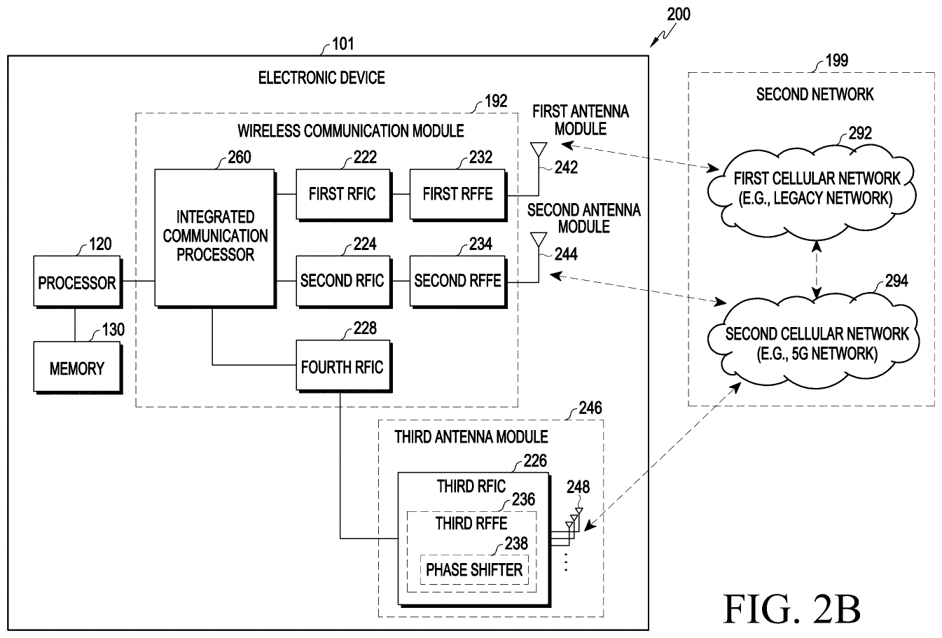

FIG. 2A is a block diagram 200 of the electronic device 101 for supporting legacy network communication and 5G network communication according to an embodiment of the disclosure.

Referring to FIG. 2A, the electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 246, and antennas 248. The electronic device 101 may further include the processor 120 and the memory 130. The second network 199 may include a first cellular network 292 and a second cellular network 294. According to another embodiment, the electronic device 101 may further include at least one component among the components illustrated in FIG. 1, and the second network 199 may further include at least one other network. According to an embodiment, the first communication processor 212, the second communication processor 214, the first RFIC 222, the second RFIC 224, the fourth RFIC 228, the first RFFE 232, and the second RFFE 234 may be at least part of the wireless communication module 192. According to another embodiment, the fourth RFIC 228 may be omitted, or may be included as part of the third RFIC 226.

The first communication processor 212 may establish a communication channel of a band to be used for wireless communication with the first cellular network 292, and may support legacy network communication via the established communication channel. According to embodiments, the first cellular network may be a legacy network including a second generation (2G), third generation (3G), 4G, or long term evolution (LTE) network. The second communication processor 214 may establish a communication channel corresponding to a designated band (e.g., approximately 6 GHz to 60 GHz) among bands to be used for wireless communication with the second cellular network 294, and may support 5G network communication via the established communication channel. According to embodiments, the second cellular network 294 may be a 5G network defined in third generation partnership project (3GPP). Additionally, according to an embodiment, the first communication processor 212 or the second communication processor 214 may establish a communication channel corresponding to another designated band (e.g., 6 GHz or less) among bands to be used for wireless communication with the second cellular network 294, and may support 5G network communication via the established communication channel.

The first communication processor 212 may perform data transmission or reception with the second communication processor 214. For example, data which has been classified to be transmitted via the second cellular network 294 may be changed to be transmitted via the first cellular network 292. In this instance, the first communication processor 212 may receive transmission data from the second communication processor 214. For example, the first communication processor 212 may perform data transmission or reception with the second communication processor 214 via an inter-processor interface 213. The inter-processor interface 213 may be implemented as, for example, a universal asynchronous receiver/transmitter (UART) (e.g., high speed-UART (HS-UART)) or a peripheral component interconnect bus express (PCIe) interface, but the type of interface is not limited. Alternatively, the first communication processor 212 and the second communication processor 214, for example, may exchange control information and packet data information by using shared memory. The first communication processor 212 may perform transmission or reception of various types of information such as sensing information, information on an output strength, and resource block (RB) allocation information, with the second communication processor 214.

Depending on the embodiment, the first communication processor 212 may not be directly connected to the second communication processor 214. In this instance, the first communication processor 212 may perform data transmission or reception with the second communication processor 214 via the processor 120 (e.g., application processor). For example, the first communication processor 212 and the second communication processor 214 may perform data transmission or reception with the processor 120 (e.g., application processor) via an HS-UART interface or a PCIe interface, but the type of interface is not limited. Alternatively, the first communication processor 212 and the second communication processor 214 may exchange control information and packet data information with the processor 120 (e.g., application processor) using shared memory.

According to an embodiment, the first communication processor 212 and the second communication processor 214 may be embodied in a single chip or a single package. According to an embodiment, the first communication processor 212 or the second communication processor 214 may be embodied in a single chip or a single package, together with the processor 120, the sub-processor 123, or the communication module 190.

FIG. 2B is a block diagram of an electronic device for supporting legacy network communication and 5G network communication according to an embodiment of the disclosure.

Referring to FIG. 2B, an integrated communication processor 260 may support all functions for communication with the first cellular network 292 and the second cellular network 294.

As described above, at least one of the processor 120, the first communication processor 212, the second communication processor 214, or the integrated communication processor 260 may be embodied as a single chip or a single package. In this instance, the single chip or single package may include memory (or storage device) for storing instructions that cause execution of at least a portion of the operations performed according to embodiments, and a processing circuit (or an operation circuit or the like, and of which the name is not limited) for implementing instructions.

In the case of transmission, the first RFIC 222 may convert a baseband signal generated by the first communication processor 212 into a radio frequency (RF) signal in the range of approximately 700 MHz to 3 GHZ, which is used for the first cellular network 292 (e.g., legacy network). In the case of reception, an RF signal may be obtained from the first cellular network 292 (e.g., legacy network) via an antenna (e.g., first antenna module 242), and may be preprocessed via an RFFE (e.g., first RFFE 232). The first RFIC 222 may convert the preprocessed RF signal into a baseband signal so that the signal is processed by the first communication processor 212.

In the case of transmission, the second RFIC 224 may convert a baseband signal generated by the first communication processor 212 or the second communication processor 214 into an RF signal (hereinafter, 5G Sub6 RF signal) in an Sub6 band (e.g., approximately 6 GHz or less) used in the second cellular network 294 (e.g., 5G network). In the case of reception, a 5G Sub6 RF signal may be obtained from the second cellular network 294 (e.g., 5G network) via an antenna (e.g., second antenna module 244), and may be preprocessed by an RFFE (e.g., second RFFE 234). The second RFIC 224 may convert the preprocessed 5G Sub6 RF signal into a baseband signal so that the signal may be processed by a corresponding communication processor among the first communication processor 212 or the second communication processor 214.

The third RFIC 226 may convert a baseband signal generated by the second communication processor 214 into an RF signal (hereinafter, 5G Above6 RF signal) of a 5G Above6 band (e.g., approximately 6 GHz to 60 GHz) to be used for the second cellular network 294 (e.g., 5G network). In the case of reception, a 5G Above6 RF signal may be received from the second cellular network 294 (e.g., 5G network) via an antenna (e.g., antenna 248), and may be preprocessed by the third RFFE 236. The third RFIC 226 may convert the preprocessed 5G Above6 RF signal into a baseband signal so that the signal may be processed by the second communication processor 214. According to an embodiment, the third RFFE 236 may be embodied as part of the third RFIC 226.

The electronic device 101, according to an embodiment, may include the fourth RFIC 228, separately from the third RFIC 226 or as part of the third RFIC 226. In this instance, the fourth RFIC 228 may convert a baseband signal generated by the second communication processor 214 into an RF signal (hereinafter, IF signal) in an intermediate frequency band (e.g., approximately 9 GHz to 11 GHZ), and may transfer the IF signal to the third RFIC 226. The third RFIC 226 may convert the IF signal into a 5G Above6 RF signal. In the case of reception, a 5G Above6 RF signal may be received from the second cellular network 294 (e.g., 5G network) via an antenna (e.g., antenna 248), and may be converted into an IF signal by the third RFIC 226. The fourth RFIC 228 may convert an IF signal into a baseband signal so that the second communication processor 214 may process the signal.

According to an embodiment, the first RFIC 222 and the second RFIC 224 may be embodied as at least part of a single chip or a single package. According to an embodiment, if the first RFIC 222 and the second RFIC 224 are embodied as a single chip or a single package in FIG. 2A or 2B, they may be embodied as an integrated RFIC. In this instance, the integrated RFIC may be connected to the first RFFE 232 and the second RFFE 234, may convert a baseband signal into a signal in a band supported by the first RFFE 232 and/or the second RFFE 234, and may transmit the converted signal to one of the first RFFE 232 and the second RFFE 234. According to an embodiment, the first RFFE 232 and the second RFFE 234 may be embodied as at least part of a single chip or a single package. According to an embodiment, at least one of the first antenna module 242 or the second antenna module 244 may be omitted, or may be combined with another antenna module, so as to process RF signals of a plurality of corresponding bands.

According to an embodiment, the third RFIC 226 and the antenna 248 may be disposed in the same substrate, and may form the third antenna module 246. For example, the wireless communication module 192 or the processor 120 may be disposed in a first substrate (e.g., main PCB). In this instance, the third RFIC 226 may be disposed in a part (e.g., lower part) of a second substrate (e.g., sub PCB) different from the first substrate, and the antenna 248 may be disposed in another part (e.g., upper part), so that the third antenna module 246 may be formed. By disposing the third RFIC 226 and the antenna 248 in the same substrate, the length of a transmission line therebetween may be reduced. For example, this may reduce a loss (e.g., diminution) of a high-frequency band signal (e.g., approximately 6 GHz to 60 GHz) used for 5G network communication, the loss being caused by a transmission line. Accordingly, the electronic device 101 may improve the quality or speed of communication with the second cellular network 294 (e.g., 5G network).

According to an embodiment, the antenna 248 may be embodied as an antenna array including a plurality of antenna elements which may be used for beamforming. In this instance, the third RFIC 226 may be, for example, part of the third RFFE 236, and may include a plurality of phase shifters 238 corresponding to a plurality of antenna elements. In the case of transmission, each of the plurality of phase shifters 238 may shift the phase of a 5G Above6 RF signal to be transmitted to the outside of the electronic device 101 (e.g., a base station of the 5G network) via a corresponding antenna element. In the case of reception, each of the plurality of phase shifters 238 may shift the phase of a 5G Above6 RF signal received from the outside via a corresponding antenna element into the same or substantially the same phase. This may enable transmission or reception via beamforming between the electronic device 101 and the outside.

The second cellular network 294 (e.g., 5G network) may operate independently (e.g., stand-alone (SA)) from the first cellular network 292 (e.g., legacy network), or may operate by being connected thereto (e.g., non-standalone (NSA)). For example, in the 5G network, only an access network (e.g., 5G radio access network (RAN) or next generation RAN (NG RAN)) may exist, and a core network (e.g., next generation core (NGC)) may not exist. In this instance, the electronic device 101 may access the access network of the 5G network, and may access an external network (e.g., the Internet) under the control of the core network (e.g., evolved packed core (EPC)) of the legacy network. Protocol information (e.g., LTE protocol information) for communication with the legacy network or protocol information (e.g., new radio (NR) protocol information) for communication with the 5G network may be stored in the memory 230, and may be accessed by another component (e.g., processor 120, first communication processor 212, or second communication processor 214).

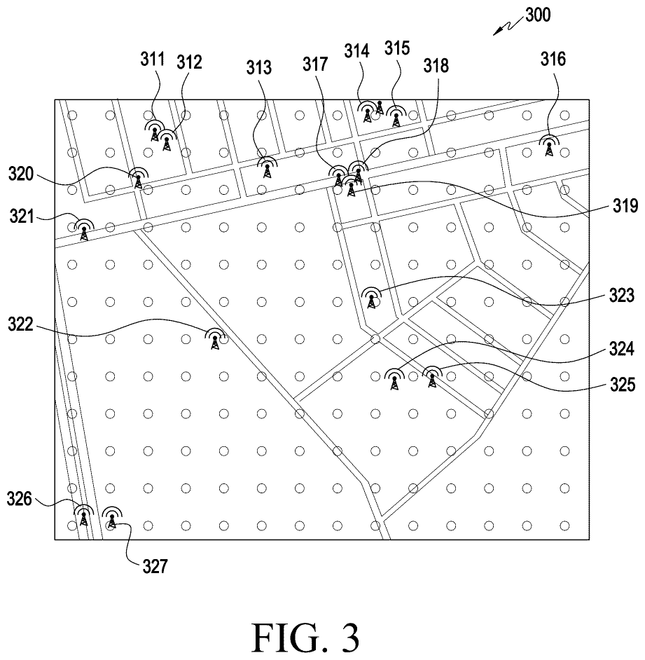

FIG. 3 is a diagram illustrating an example of an electric field map according to an embodiment of the disclosure.

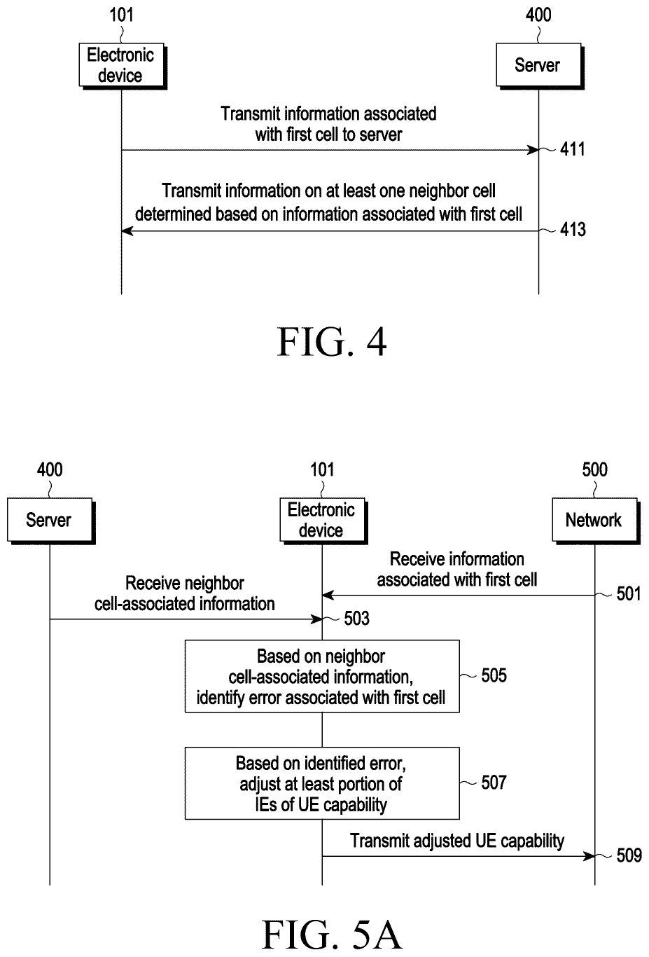

The embodiment of FIG. 3 will be described with reference to FIG. 4.

FIG. 4 is a flowchart illustrating an operation method of an electronic device and a server according to an embodiment of the disclosure.

According to an embodiment, an electric field map 300 may include a location of at least one base station 311 to 327 in a predetermined area and information on electric fields associated with a plurality of points in the predetermined area. For example, the location of the at least one base station 311 to 327 in the electric field map 300 may be expressed as latitude/longitude information or GPS coordinates, but the expression method is not limited to thereto. The plurality of points in the predetermined area may be defined in a lattice form as shown in FIG. 3, but the definition method is not limited thereto. The information on the electric fields associated with the plurality of points may be, for example, received strengths at the corresponding points (e.g., expressed as RSRP, RSRQ, RSSI, or SINR, but not limited thereto), but this is merely an example. A network provider and/or a location service provider may generate at least a portion of the information associated with the electric field map 300, for example, based on information reported from an electronic device that uses a network service and is located in at least a portion of the plurality of points. The network provider may generate at least a portion of the information associated with the electric field map 300, for example, based on information measured by a measurement equipment located at least a portion of the plurality of points. At least a portion of the electric field map 300 may be provided by another network provider and/or location service provider. The network provider may increase a network quality by using the electric field map 300. For example, to increase an electric field at a point that corresponds to a relatively weak electric field, the network provider may additionally install a base station or a cell in the corresponding point.

According to an embodiment, a server 400 by the network provider and/or location service provider may configure information on a neighbor cell associated with a predetermined cell for the information associated with the electric field map 300. The server 400 may be established, for example, by a network provider and/or location service provider, and may collect information using a crowd sourcing scheme but the disclosure is not limited thereto. The electronic device 101, for example, may perform data transmission or reception with the server 400 via internet communication (or internet PDU session). The electronic device 101, for example, may execute an application capable of performing data transmission or reception with the server 400. For example, data transmitted or received between the electronic device 101 and the server 400 may be data in an application layer, but the disclosure is not limited thereto. For example, the electronic device 101 may receive neighbor cell-associated information (e.g., system information block (SIB)) from a network (cell or base station). Independently from the above, the electronic device 101 may receive neighbor cell-associated information from the server 400, and may name the information big data-based neighbor cell-associated information, in order to distinguish the information from the information (e.g., SIB) received from the network. For example, in the big data-based neighbor cell-associated information, information on a neighbor cell may include, for example, cell identification information, location information (e.g., latitude/longitude or GPS coordinates), radio access technology (RAT) information, frequency information (e.g., absolute radio-frequency channel number (ARFCN)), carrier aggregation (CA)/dual connectivity (DC) band information, information associated with a call drop, information associated with abnormal termination (crash) of an electronic device or application, information associated with a plasma display panel (PDP) failure, a Voice over Internet Protocol (VOIP) failure rate, an IMS registration failure rate, information associated with an attach failure, information associated with a radio link failure (RLF), and/or information associated with a size of a UE capability, but the disclosure is not limited thereto.

Referring to FIG. 4, the electronic device 101 (e.g., processor 120, first communication processor 212, second communication processor 214, and/or integrated communication processor 260) may transmit information associated with a first cell to the server 400 in operation 411. For example, the electronic device 101 may transmit cell identification information (physical cell ID) of the first cell to the server 400, and any information capable of identifying the first cell is used as the information associated with the first cell without restriction. In operation 413, the server 400 may transmit, to the electronic device 101, information on at least one neighbor cell determined based on the information associated with the first cell.

As an example, based on a stored connection history, the electronic device 101 may transmit, to the server 400, information on cells that were connected in the past and/or are connected currently. The information transmitted from the electronic device 101 to the server 400 may include, for example, cell identification information, location information (e.g., latitude/longitude or GPS coordinates), radio access technology (RAT) information, frequency information (e.g., ARFCN), CA/DC band information, information associated with a call drop, information associated with abnormal termination (crash) of an electronic device or application, information associated with a PDP failure, a VoIP failure rate, an IMS registration failure rate, information associated with an attach failure, information associated with a radio link failure (RLF), and/or information associated with a size of a UE capability, but the disclosure is not limited thereto. The transmitted information, for example, may be used for configuring big data according to a crowd sourcing scheme, but the disclosure is not limited thereto. For example, the electronic device 101 may transmit, to the server 400, information on a plurality of cells that were connected in the past. Based on the received information on the plurality of cells, the server 400 may configure information on at least one cell and may transmit the same to the electronic device 101. In order to request big data information, the electronic device 101 may transmit only information for cell identification to the server 400. For example, the electronic device 101 may transmit, to the server 400, information (e.g., cell identification information) on cells where the electronic device 101 stayed relatively long time. As an example, the electronic device 101 may transmit, to the server 400, information (e.g., cell identification information) on a predetermined number (e.g., 20) of cells where the electronic device 101 stayed lately. Based on the received information on the cells, the server 400 may configure information on at least one cell and may transmit the same to the electronic device 101. For example, the electronic device 101 may transmit, to the server 400, information on cells 323, 324, and 325 of FIG. 3. Based on the fact that the electronic device 101 is located near the cells 323, 324, and 325, the server 400 may configure information on neighbor cells (e.g., cells 311 to 327) of the cells 323, 324, and 325 as neighbor cell information, and may transmit the same to the electronic device 101. Those skilled in the art field may understand that information on a cell currently connected may be transmitted to the electronic device 101.

For example, the electronic device 101 may transmit, to the server 400, information on the first cell currently connected. Based on the received information on the first cell, the server 400 may configure information on at least one neighbor cell and may transmit the same to the electronic device 101. For example, in the state of being connected to the cell 323 of FIG. 3, the electronic device 101 may transmit, to the server 400, information on the cell 323. Based on the fact that the electronic device 101 is connected to the cell 323, the server 400 may configure information on neighbor cells (e.g., cells 311 to 327) of the cell 323 as neighbor cell information, and may transmit the same to the electronic device 101. Information transmitted from the electronic device 101 and used by the server 400 for identifying a neighbor cell is not limited.

For example, the electronic device 101 may transmit, to the server 400, information on a cell where a designated event occurs. Here, the event may include, for example, a call drop, crash, PDP failure, attach (or registration) failure, and/or radio link failure (RLF), but the type of event is not limited thereto. Based on the received information on the cell, the server 400 may configure information on at least one neighbor cell and may transmit the same to the electronic device 101. For example, based on the event occurring in the cell 323 of FIG. 3, the electronic device 101 may transmit information on the cell 323 to the server 400. Based on the fact that the electronic device 101 is connected to the cell 323, the server 400 may configure information on neighbor cells (e.g., cells 311 to 327) of the cell 323 as neighbor cell information, and may transmit the same to the electronic device 101. Information transmitted from the electronic device 101 and used by the server 400 for identifying a neighbor cell is not limited. In addition, those skilled in the art may understand that the neighbor cell information may include information on a cell (e.g., first cell) that the electronic device 101 is currently connected to.

For example, the electronic device 101 may transmit information on a cell in designated cycles, and may receive information on a neighbor cell from the server 400. For example, based on Wi-Fi communication connected, the electronic device 101 may transmit information on a cell, and may receive information on a neighbor cell from the server 400. For example, when the above-described event is detected, the electronic device 101 may transmit information on a cell, and may receive information on a neighbor cell from the server 400. A point in time at which the electronic device 101 receives information from the server 400 and/or an event is not limited, and depending on the embodiment, although information is not received from the electronic device 101, the server 400 may unilaterally provide information on at least one neighbor cell to the electronic device 101.

As described above, the electronic device 101 may transmit information on a cell to the server 400, and the server 400 may configure, based on the received information, information on at least one neighbor cell to be transmitted to the electronic device 101. The server 400, for example, may update the electric field map 300 by using the information on the cell received from the electronic device 101.

In an alternative example, the electronic device 101 may transmit location information (e.g., latitude/longitude or GPS coordinates), instead of information on a cell, to the server 400. Based on the received location information, the server 400 may configure information on at least one neighbor cell to be transmitted to the electronic device 101. For example, the electronic device 101 may transmit the current location information to the server 400, and the server 400 may transmit, to the electronic device 101, information on at least one neighbor cell located around the current location information.

According to an embodiment, the electronic device 101 may perform RAN-associated operation and/or core network-associated operation by using the received information on at least one neighbor cell, and the disclosure is not limited thereto. For example, the electronic device 101 may perform cell selection, cell reselection, and/or UE capability adjustment by using the received information on at least one neighbor cell, and this will be described later. As described above, a network may have the probability of not providing, to the electronic device 101, part of information on the entire neighbor cells. In this instance, the electronic device 101 may not receive information from the network, but may use information on a neighbor cell received from the server 400, and may operate by using information on substantially the entire neighbor cells. In addition, the network may not provide information associated with a call drop, information associated with abnormal termination (crash) of an electronic device or application, information associated with a PDP failure, a VOIP failure rate, an IMS registration failure rate, information associated with an attach failure, information associated with a radio link failure (RLF), and/or information associated with a size of a UE capability. Based on crowd sourcing, the information associated with a call drop, information associated with abnormal termination (crash) of an electronic device or application, information associated with a PDP failure, a VoIP failure rate, an IMS registration failure rate, information associated with an attach failure, information associated with a radio link failure (RLF), and/or information associated with a size of a UE capability may be provided to the electronic device 101, and the electronic device 101 may use the received information and may avoid an operation with a relatively high probability of having an error and/or connection to a cell with a relatively high probability of having an error.

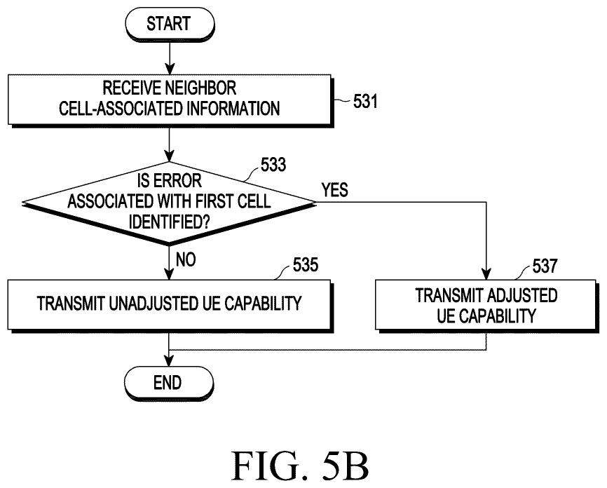

FIG. 5A is a flowchart illustrating an operation method of an electronic device according to an embodiment of the disclosure.

According to an embodiment, the electronic device 101 (e.g., processor 120, first communication processor 212, the second communication processor 214, and/or integrated communication processor 260) may receive, from a network 500, information associated with a first cell in operation 501. For example, before the electronic device 101 is connected to the first cell, while establishing a connection, and/or after establishing the connection, the electronic device 101 may receive at least one system information from the network 500. Any system information defined in 3GPP may be used as the system information without any restriction. Those skilled in the art may understand that the electronic device 101 may receive, from the network 500, information associated with a neighbor cell of the first cell, in addition to the information associated with the first cell.

According to an embodiment, the electronic device 101 may receive neighbor cell-associated information from the server 400 in operation 503. For example, after establishing the connection via the network 500, the electronic device 101 may receive the neighbor cell-associated information via the established connection. For example, based on another network communication (e.g., IEEE 802.11 based communication), the electronic device 101 may receive neighbor cell-associated information from the server 400. For example, the electronic device 101 may transmit information associated with the first cell and/or information associated with a location of the electronic device 101 to the server 400, and the server 400 may configure, based on the received information, neighbor cell-associated information to be transmitted. The neighbor cell-associated information received from the server 400 may include, as described above, cell identification information, location information (e.g., latitude/longitude or GPS coordinates), radio access technology (RAT) information, frequency information (e.g., ARFCN), CA/DC band information, information associated with a call drop, information associated with abnormal termination (crash) of an electronic device or application, information associated with a PDP failure, a VOIP failure rate, an IMS registration failure rate, information associated with an attach failure, information associated with a radio link failure (RLF), and/or information associated with a size of a UE capability, but the disclosure is not limited thereto. The location information (e.g., latitude/longitude or GPS coordinates), information associated with a call drop, information associated with abnormal termination (crash) of an electronic device or application, information associated with a PDP failure, VOIP failure rate, IMS registration failure rate, information associated with an attach failure, information associated with a radio link failure (RLF), and/or information associated with a size of a UE capability, transmitted from the server 400, may not be included in conventional system information. Accordingly, the electronic device 101 may additionally use information that is not included in conventional system information. Those skilled in the art may understand that the neighbor cell-associated information received from the server 400 may include information on a cell that the electronic device 101 is currently connected to (or camps on).

According to an embodiment, in operation 505, based on the neighbor cell-associated information received from the server 400, the electronic device 101 may identify an error associated with the first cell. As an example, there is the probability that an error occurs based on a size of a UE capability. For example, a size of a UE capability that the first cell (or Tracking Area Identity (TAI) that the first cell belongs to) of the network 500 is capable of processing may be a first size. A size of a UE capability pre-stored in the electronic device 101 may be a second size. When the second size is larger than the first size, there is the probability that the network 500 fails to identify a UE capability. As an example, in a corresponding cell, based on a flag indicating whether an error occurs based on a size of a UE capability, the electronic device 101 may identify an error associated with the corresponding cell. For example, Table 1 is an example of a “TAI_EVENT” field of information received from the server 400 according to an embodiment.

TABLE 1

| | BIT | | | | | | | |
|---|---|---|---|---|---|---|---|---|
| | 0 | 1 | 2 | 3 | 4 | 5 | 6 | 7 |
| | (uecapa | (event | (event | (event | (event | (event | (event | (event |
| | event) | 1) | 2) | 3) | 4) | 5) | 6) | 7) |
| Value | 1 | 0 | 0 | 0 | 0 | 1 | 0 | 0 |

For example, whether an event occurs in a corresponding cell, for various types of events, may be expressed in the form of a flag in “TAI_EVENT.” For example, “uecapaevent” of Table 1 is a field indicating that an error based on a size of a UE capability occurs, and a value of “1” indicates that a related error occurs and a value of “0” indicates that a related error does not occur. As illustrated in Table 1, 8 types of TAI-related events may be expressed, but the number of events is not limited thereto. In the “TAI_EVENT” field, for example, events that may be equally applied to a TAI that the corresponding cell belongs to may be included, but the disclosure is not limited thereto. As an example, in the information received from the server 400, “TAI” and “TAI_EVENT” are successively expressed but the expression scheme is not limited thereto. In Table 1, errors corresponding to “event_0” and “event_5” may have the value of “1,” and the electronic device 101 may perform an operation associated with the error corresponding to “event_0” and “event_5.” For example, as described above, the operation associated with the error corresponding to “event_0” may be adjusting at least one IE of a UE capability (e.g., adjusting of a CA/DC band combination), but the operation is not limited thereto. In operation 507, based on the identified error, the electronic device 101 may adjust at least a portion of the IEs of a UE capability. For example, when reporting a UE capability associated with the first cell (or the TAI that the first cell belongs to), the electronic device 101 may adjust, based on the identified error, at least a portion of the IEs of the UE capability. For example, when the identified error is associated with a size of a UE capability, the electronic device 101 may perform adjustment in order to decrease the size of the UE capability. For example, the electronic device 101 may adjust IEs of a supported frequency, a carrier aggregation (CA) combination, and/or a dual connectivity (DC) combination, thereby decreasing the size of the UE capability. For example, it is assumed that a CA combination and/or DC combination supported by the electronic device 101 is a combination of f1, f2, f3, f4, f5, and f6. When an error is not expected, the electronic device 101 may include the combination of f1, f2, f3, f4, f5, and f6 in the CA combination and/or DC combination. When an error is expected, the electronic device 101 may exclude at least a portion of the combination of f1, f2, f3, f4, f5, and f6 from the UE capability. For example, when, based on the neighbor cell-associated information received from the server 400, it is identified that frequencies supported by the current cell and a neighbor cell are f3 and f6, the electronic device 101 may include a combination of f3 and f6 in the CA combination and/or DC combination, thereby adjusting the IEs of the UE capability. Those skilled in the art may understand that any IE that is capable of decreasing the size of the UE capability may be used without any restriction. In operation 509, the electronic device 101 may transmit the adjusted UE capability to the network 500. The size of the adjusted UE capability, for example, may be less than or equal to a size capable of being processed by the network 500, and thus an error caused by a size of a UE capability may be prevented.

Although not illustrated, after adjusting at least a portion of the IEs of the UE capability, the electronic device 101 may move to another cell (or another TAI). In this instance, the electronic device 101 may identify a UE capability size capable of being processed by the other cell (or other TAI), and may compare the size with the size of the UE capability stored in advance in the electronic device 101. For example, when the UE capability size capable of being processed by the other cell (or other TAI) to which the electronic device moves is larger than or equal to the size of the UE capability stored in advance in the electronic device 101, the electronic device 101 may not need to adjust the IEs of the UE capability. Accordingly, when having an opportunity to transmit a UE capability, the electronic device 101 may transmit the UE capability stored in advance therein to the network 500 without any adjustment.

According to an embodiment, the electronic device 101 may determine an IE to be adjusted and/or a degree of adjustment by using the UE capability size capable of being processed by the corresponding cell (or TAI including the corresponding cell), and the size of the UE capability stored in advance in the electronic device 101. For example, the difference between a UE capability size that the first cell (or first TAI including the first cell) capable of processing and the size of the UE capability stored in advance in the electronic device 101, and the difference between a UE capability size that a second cell (or second TAI including the second cell) capable of processing and the size of the UE capability stored in advance in the electronic device 101 may be different. Based on a difference in size, the electronic device 101 may select at least one IE to be adjusted and/or may determine the amount of information to be included in an IE. As an example, when the difference in size is relatively small, the electronic device 101 may determine only a DC combination as an IE to be adjusted. When the difference in size is relatively large, the electronic device 101 may determine a DC combination and a CA combination as IEs to be adjusted. As an example, when the difference in size is relatively small, the electronic device 101 may determine a frequency combination to be excluded from the DC combination to have a first number. When the difference in size is relatively large, the electronic device 101 may determine the frequency combination to be excluded from the DC combination to have a second number that is larger than the first number. As described above, the electronic device 101 may dynamically adjust the IEs of the UE capability for each cell (or for each TAI).

FIG. 5B is a flowchart illustrating an operation method of an electronic device according to an embodiment of the disclosure.

According to an embodiment, the electronic device 101 (e.g., processor 120, first communication processor 212, second communication processor 214, and/or integrated communication processor 260) may receive neighbor cell-associated information from the server 400 in operation 531. In the neighbor cell-associated information, information on a cell that the electronic device 101 is currently connected to (or camps on) and/or a neighbor cell of the corresponding cell may be included. In operation 533, the electronic device 101 may identify whether an error associated with a first cell (or first TAI that the first cell belongs to) is identified. For example, based on comparison between a size of a UE capability that a predetermined cell (or TAI that the predetermined cell belongs to) is capable of processing, and a size of a UE capability stored in advance in the electronic device 101, the electronic device 101 may identify whether an error is identified. An error caused by a size of a UE capability is merely an example, the types of errors are not limited and will be described later.

According to an embodiment, when an error associated with the first cell (or the first TAI that the first cell belongs to) is not identified (No in operation 533), the electronic device 101 may transmit an unadjusted UE capability to the network 500 in operation 535. When an error associated with the first cell (or the first TAI that the first cell belongs to) is identified (Yes in operation 533), the electronic device 101 may transmit, to the network 500, a UE capability with IEs that are at least partially adjusted in operation 537. When the electronic device 101 fails to receive the neighbor cell-associated information of operation 531 or fails to store the same in advance, the electronic device 101 may be incapable of identifying whether an error associated with the first cell occurs in operation 533. Accordingly, when failing to receive the neighbor cell-associated information or failing to store the same in advance, the electronic device 101 may transmit the unadjusted UE capability. Afterward, when the electronic device 101 receives neighbor cell-associated information and identifies an error, the electronic device 101 may transmit a UE capability with IEs that are at least partially adjusted. Accordingly, even in the same TAI, based on whether neighbor cell-associated information is received, the electronic device 101 may transmit the unadjusted UE capability or may transmit a UE capability with IEs that are at least partially adjusted.

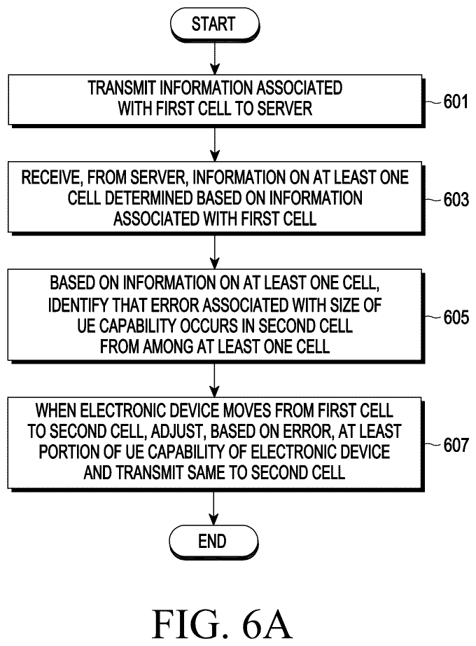

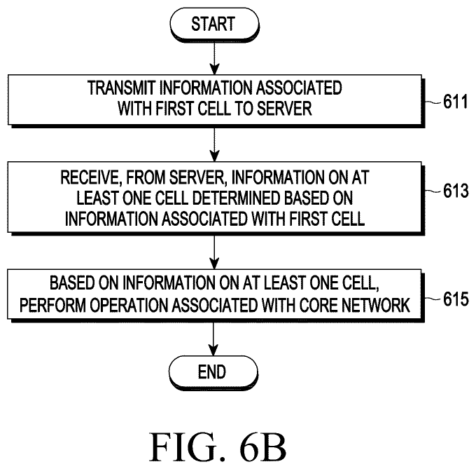

FIG. 6A is a flowchart illustrating an operation method of an electronic device according to an embodiment of the disclosure.

According to an embodiment, the electronic device 101 (e.g., processor 120, first communication processor 212, second communication processor 214, and/or integrated communication processor 260) may transmit information associated with a first cell (e.g., information capable of identifying a cell but not limited thereto) to the server 400 in operation 601. Based on the information associated with the first cell, the server 400 may configure information on at least one neighbor cell to be transmitted to the electronic device 101. As described above, in addition to (or instead of) information associated with the first cell, the electronic device 101 may transmit location information (e.g., latitude/longitude or GPS coordinates) to the server 400. Based on the received location information, the server 400 may configure information on at least one neighbor cell to be transmitted to the electronic device 101.

According to an embodiment, in operation 603, the electronic device 101 may receive, from the server 400, information on at least one cell determined based on the information associated with the first cell. For example, the electronic device 101 may receive information on the first cell and/or a neighbor cell of the first cell. The received information may include, for example, cell identification information, location information (e.g., latitude/longitude or GPS coordinates), radio access technology (RAT) information, frequency information (e.g., ARFCN), carrier aggregation (CA)/DC band information, information associated with a call drop, information associated with abnormal termination (crash) of an electronic device or application, information associated with a PDP failure, a VOIP failure rate, an IMS registration failure rate, information associated with an attach failure, information associated with a radio link failure (RLF), and/or information associated with a size of a UE capability, but the disclosure is not limited thereto.

According to an embodiment, in operation 605, the electronic device 101 may identify that an error associated with a size of a UE capability occurs in a second cell among the at least one cell. For example, the electronic device 101 may identify that a value of “1” is written in a “uecapaevent” field of information associated with a TAI event, as shown in Table 1, in information associated with the second cell, and thus may identify that an error associated with a size of a UE capability occurs in the second cell. However, the identification method is not limited thereto. In operation 607, when the electronic device 101 moves from the first cell to the second cell, the electronic device 101 may adjust at least a portion of a UE capability of the electronic device 101 based on the error and may transmit the same to the second cell. When a UE capability request is received from the network 500, the electronic device 101 may transmit an adjusted UE capability. Depending on the case, when a UE capability request is not received from the network 500, the electronic device 101 may perform at least one operation to cause reporting of the UE capability.

FIG. 6B is a flowchart illustrating an operation method of an electronic device according to an embodiment of the disclosure.

According to an embodiment, the electronic device 101 (e.g., processor 120, first communication processor 212, second communication processor 214, and/or integrated communication processor 260) may transmit information associated with a first cell (e.g., information capable of identifying a cell but not limited thereto) to the server 400 in operation 611. Based on the information associated with the first cell, the server 400 may configure information on at least one neighbor cell to be transmitted to the electronic device 101. As described above, in addition to (or instead of) the information associated with the first cell, the electronic device 101 may transmit location information (e.g., latitude/longitude or GPS coordinates) to the server 400. Based on the received location information, the server 400 may configure information on at least one neighbor cell to be transmitted to the electronic device 101.

According to an embodiment, in operation 613, the electronic device 101 may receive, from the server 400, the information on at least one cell determined based on the information associated with the first cell. For example, the electronic device 101 may receive information on the first cell and/or a neighbor cell of the first cell. The received information may include, for example, cell identification information, location information (e.g., latitude/longitude or GPS coordinates), radio access technology (RAT) information, frequency information (e.g., ARFCN), carrier aggregation (CA)/DC band information, information associated with a call drop, information associated with abnormal termination (crash) of an electronic device or application, information associated with a PDP failure, a VOIP failure rate, an IMS registration failure rate, information associated with an attach failure, information associated with a radio link failure (RLF), and/or information associated with a size of a UE capability, but the disclosure is not limited thereto. According to an embodiment, in operation 615, the electronic device 101 may perform a core network-associated operation based on the information on the at least one cell. As an example, based on whether an error associated with a size of a UE capability occurs, the electronic device 101 may determine whether to adjust at least a portion of the UE capability, and other examples associated with a core network will be described later.

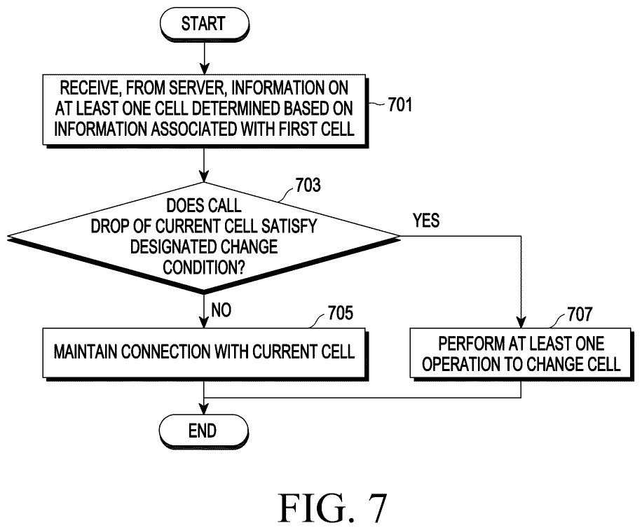

FIG. 7 is a flowchart illustrating an operation method of an electronic device according to an embodiment of the disclosure.

According to an embodiment, the electronic device 101 (e.g., processor 120, first communication processor 212, second communication processor 214, and/or integrated communication processor 260) may receive, from the server 400, information on at least one cell determined based on information associated with a first cell in operation 701. For example, the electronic device 101 may receive information on the first cell and/or a neighbor cell of the first cell. The received information may include information associated with a call drop, and may additionally include cell identification information, location information (e.g., latitude/longitude or GPS coordinates), radio access technology (RAT) information, frequency information (e.g., ARFCN), carrier aggregation (CA)/DC band information, information associated with abnormal termination (crash) of an electronic device or application, information associated with a PDP failure, a VOIP failure rate, an IMS registration failure rate, information associated with an attach failure, information associated with radio link failure (RLF), and/or information associated with a size of a UE capability.

According to an embodiment, in operation 703, the electronic device 101 may identify whether a call drop of the current cell satisfies a designated change condition. As an example, when information associated with the call drop is expressed as a call drop rate, the electronic device 101 may identify whether the call drop rate is greater than or equal to a threshold value so as to identify whether the designated change condition is satisfied. As an example, when the information associated with the call drop is expressed in the form of a flag, the electronic device 101 may identify whether a call drop occurs (e.g., whether a flag indicates a designated value) so as to identify whether the designated change condition is satisfied, and the method of expressing the information associated with a call drop is not limited thereto. When the call drop does not satisfy the designated change condition (No in operation 703), the electronic device 101 may maintain the connection with the current cell in operation 705. When the call drop satisfies the designated change condition (Yes in operation 703), the electronic device 101 may perform at least one operation for cell change in operation 707. For example, the electronic device 101 may perform at least one operation for cell change in a manner that decreases the priority of the corresponding cell, but the type of operation is not limited thereto.

As another example, based on information associated with a radio link failure (RLF), the electronic device 101 may determine whether to perform an operation for cell change. As an example, when information associated with the RLF is expressed as an RLF incidence rate, the electronic device 101 may identify whether the RLF incidence rate is greater than or equal to a threshold value so as to identify whether the designated change condition is satisfied. As an example, when the information associated with the RLF is expressed in the form of a flag, the electronic device 101 may identify whether an RLF occurs (e.g., whether a flag indicates a designated value) so as to identify whether the designated change condition is satisfied, and for the method of expressing the information associated with an RLF is not limited thereto. When the information associated with the RLF does not satisfy the designated change condition, the electronic device 101 may maintain the connection with the current cell. When the information associated with the RLF satisfies the designated change condition, the electronic device 101 may perform at least one operation for cell change. For example, the electronic device 101 may perform at least one operation for cell change in a manner that decreases the priority of the corresponding cell, but the type of operation is not limited thereto.

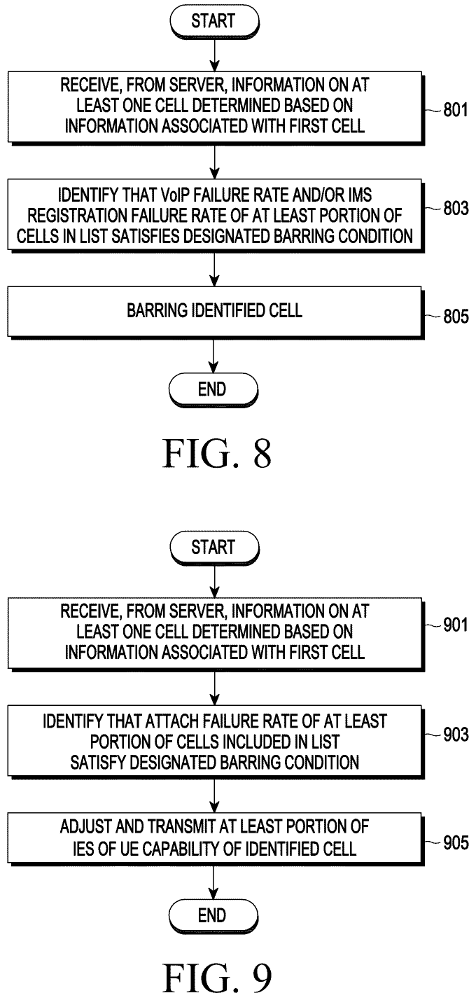

FIG. 8 is a flowchart illustrating an operation method of an electronic device according to an embodiment of the disclosure.

According to an embodiment, the electronic device 101 (e.g., processor 120, first communication processor 212, second communication processor 214, and/or integrated communication processor 260) may receive, from the server 400, information on at least one cell determined based on information associated with a first cell in operation 801. For example, the electronic device 101 may receive information on the first cell and/or a neighbor cell of the first cell. The received information may include a VOIP failure rate and/or IMS registration failure rate, and may additionally include cell identification information, location information (e.g., latitude/longitude or GPS coordinates), radio access technology (RAT) information, frequency information (e.g., ARFCN), carrier aggregation (CA)/DC band information, information associated with a call drop, information associated with abnormal termination (crash) of an electronic device or application, information associated with a PDP failure, information associated with an attach failure, information associated with a radio link failure (RLF), and/or information associated with a size of a UE capability.

According to an embodiment, in operation 803, the electronic device 101 may identify that the VOIP failure rate and/or IMS registration failure rate of at least a portion of the cells included in a list satisfies a designated barring condition. For example, the electronic device 101 may identify whether the VOIP failure rate is greater than or equal to a first threshold value, and/or may identify whether the IMS registration failure rate is greater than or equal to a second threshold value. When the VOIP failure rate and/or IMS registration failure rate of a predetermined cell satisfies the designated barring condition, the electronic device 101 may bar (barring) the identified cell in operation 805. When the predetermined cell is barred, movement to the predetermined cell may be prevented. The electronic device 101 may release barring of the corresponding cell after a predetermined period of time elapses, but the disclosure is not limited thereto. When the currently connected cell satisfies the barring condition, the electronic device 101 may perform an operation (e.g., operation that decreases the priority but not limited thereto) that causes movement from the corresponding cell to another cell.

FIG. 9 is a flowchart illustrating an operation method of an electronic device according to an embodiment of the disclosure.

According to an embodiment, the electronic device 101 (e.g., processor 120, first communication processor 212, second communication processor 214, and/or integrated communication processor 260) may receive, from the server 400, information on at least one cell determined based on information associated with a first cell in operation 901. For example, the electronic device 101 may receive information on the first cell and/or a neighbor cell of the first cell. The received information may include an attach failure rate, and may additionally include cell identification information, location information (e.g., latitude/longitude or GPS coordinates), radio access technology (RAT) information, frequency information (e.g., ARFCN), carrier aggregation (CA)/DC band information, information associated with a call drop, information associated with abnormal termination (crash) of an electronic device or application, information associated with a PDP failure, a VOIP failure rate, an IMS registration failure rate, information associated with a radio link failure (RLF), and/or information associated with a size of a UE capability.

According to an embodiment, in operation 903, the electronic device 101 may identify that the attach failure rate of at least a portion of the cells included in a list satisfies a designated barring condition. For example, the electronic device 101 may identify whether the attach failure rate is greater than or equal to a threshold value. When the attach failure rate of a predetermined cell satisfies the designated barring condition, the electronic device 101 may adjust at least a portion of a UE capability in operation 905. For example, when the attach failure rate is relatively high, the CA and/or DC combination may be adjusted as described above, and accordingly, the size of the UE capability may be decreased. For example, although information associated with an error associated with the size of the UE capability of the corresponding cell is not received or when information indicating that an error associated with the size of the UE capability does not occur is received, when the attach failure rate is greater than or equal to the threshold value, the electronic device 101 may adjust at least a portion of the UE capability to have a decreased size.

According to an embodiment, the electronic device 101 may include at least one processor 120, 212, 214, or 260. The at least one processor 120, 212, 214, or 260 may be configured to transmit information associated with a first cell to a server. The at least one processor 120, 212, 214, or 260 may be configured to receive, from the server, information on at least one cell determined based on the information associated with the first cell. The at least one processor 120, 212, 214, or 260 may be configured to, based on the information on the at least one cell, identify that an error associated with a size of a UE capability occurs in a second cell among the at least one cell. The at least one processor 120, 212, 214, or 260 may be configured to, based on the error, transmit at least a portion of a UE capability of the electronic device 101 to the second cell, by adjusting the at least a portion of the UE capability of the electronic device 101 in case that the electronic device 101 moves to the second cell.

According to an embodiment, as at least part of the transmitting, to the second cell, the at least a portion of the UE capability of the electronic device 101 by adjusting the at least a portion of the UE capability of the electronic device 101, the at least one processor 120, 212, 214, or 260 may be configured to exclude at least a portion of a plurality of first frequencies for carrier aggregation (CA) configured for the electronic device 101, and/or to exclude at least a portion of a plurality of second frequencies for dual connectivity (DC) configured for the electronic device 101.

According to an embodiment, as at least part of the excluding the at least a portion of the plurality of first frequencies for CA configured for the electronic device 101, and/or excluding the at least a portion of the plurality of second frequencies for DC configured for the electronic device 101, the at least one processor 120, 212, 214, or 260 may be configured to exclude at least one frequency that is not supported by the second cell, from among the plurality of first frequencies and/or the plurality of second frequencies.

According to an embodiment, the at least one processor 120, 212, 214, or 260 may be further configured to identify, based on the information on the at least one cell received from the server, at least one frequency that is not supported by the second cell.

According to an embodiment, as at least part of the identifying that the error associated with a size of a UE capability occurs in the second cell based on the information on the at least one cell, the at least one processor 120, 212, 214, or 260 may be configured to identify that the error associated with a size of a UE capability occurs in the second cell, based on identifying that a value of a field indicating whether an error associated with a size of a UE capability occurs, among information corresponding to the second cell or information corresponding to a TAI including the second cell, is a first value indicating an error.

According to an embodiment, the at least one processor 120, 212, 214, or 260 may be further configured to identify, based on the information on the at least one cell, whether information associated with a call drop of the first cell satisfies a designated first change condition. The at least one processor 120, 212, 214, or 260 may be further configured to perform at least one operation to change a cell, based on the information associated with the call drop of the first cell satisfying the first change condition.

According to an embodiment, the at least one processor 120, 212, 214, or 260 may be further configured to identify, based on the information on the at least one cell, whether information associated with an RLF of the first cell satisfies a designated second change condition. The at least one processor 120, 212, 214, or 260 may be further configured to perform at least one operation to change a cell, based on the information associated with the RLF of the first cell satisfying the second change condition.

According to an embodiment, the at least one processor 120, 212, 214, or 260 may be further configured to identify, based on the information on the at least one cell, whether a VOIP failure rate and/or IMS registration failure rate of a third cell satisfies a designated first barring condition. The at least one processor 120, 212, 214, or 260 may be further configured to bar the third cell based on the VOIP failure rate and/or IMS registration failure rate of the third cell satisfying the first barring condition.

According to an embodiment, based on an elapse of designated time after barring the third cell, the at least one processor 120, 212, 214, and 260 may be further configured to release the barring the third cell.

According to an embodiment, the at least one processor 120, 212, 214, or 260 may be further configured to identify, based on the information on the at least one cell, whether an attach failure rate of a fourth cell satisfies a designated second barring condition. The at least one processor 120, 212, 214, or 260 may be further configured to transmit at least a portion of a UE capability of the first electronic device 101 to the fourth cell by adjusting the at least a portion of the UE capability of the first electronic device 101, based on the attach failure rate of the fourth cell satisfying the second barring condition.

According to an embodiment, an operation method of the electronic device 101 may include transmitting information associated with a first cell to a server. The operation method of the electronic device 101 may include receiving, from the server, information on at least one cell determined based on the information associated with the first cell. The operation method of the electronic device 101 may include identifying, based on the information on the at least one cell, that an error associated with a size of a UE capability occurs in a second cell among the at least one cell. The operation method of the electronic device 101 may include based on the error, transmitting at least a portion of a UE capability of the electronic device 101 to the second cell by adjusting the at least a portion of the UE capability of the electronic device 101 in case that the electronic device 101 moves to the second cell.

According to an embodiment, the transmitting the at least a portion of the UE capability of the electronic device 101 to the second cell by adjusting the at least a portion of the UE capability of the electronic device 101 may comprise excluding at least a portion of a plurality of first frequencies for carrier aggregation (CA) configured for the electronic device 101, and/or may excluding at least a portion of a plurality of second frequencies for dual connectivity (DC) configured for the electronic device 101.

According to an embodiment, the excluding the at least a portion of the plurality of first frequencies for CA configured for the electronic device 101, and/or excluding the at least a portion of the plurality of second frequencies for DC configured for the electronic device 101 may comprise excluding at least one frequency that is not supported by the second cell, from among the plurality of first frequencies and/or the plurality of second frequencies.

According to an embodiment, the operation method of the electronic device 101 may further include identifying, based on the information on the at least one cell received from the server, at least one frequency that is not supported by the second cell.

According to an embodiment, the identifying that the error associated with a size of a UE capability occurs in the second cell based on the information on the at least one cell may comprise identifying that the error associated with a size of a UE capability occurs in the second cell, based on identifying that a value of a field indicating whether an error associated with a size of a UE capability occurs, among information corresponding to the second cell or information corresponding to a TAI including the second cell, is a first value indicating an error.

According to an embodiment, the operation method of the electronic device 101 may include identifying, based on the information on the at least one cell, whether information associated with a call drop of the first cell satisfies a designated first change condition. According to an embodiment, the operation method of the electronic device 101 may include performing at least one operation to change a cell, based on the information associated with the call drop of the first cell satisfying the first change condition.

According to an embodiment, the operation method of the electronic device 101 may include identifying, based on the information on the at least one cell, whether information associated with an RLF of the first cell satisfies a designated second change condition. The operation method of the electronic device 101 may include performing at least one operation to change a cell, based on the information associated with the RLF of the first cell satisfying the second change condition.

According to an embodiment, the operation method of the electronic device 101 may include identifying, based on the information on the at least one cell, whether information associated with an RLF of the first cell satisfies a designated second change condition. The operation method of the electronic device 101 may include performing at least one operation to change a cell, based on the information associated with the RLF of the first cell satisfying the second change condition.

According to an embodiment, the operation method of the electronic device 101 may include identifying, based on the information on the at least one cell, whether a VoIP failure rate and/or IMS registration failure rate of a third cell satisfies a designated first barring condition. The operation method of the electronic device 101 may include barring the third cell, based on the VOIP failure rate and/or IMS registration failure rate of the third cell satisfying the first barring condition.

According to an embodiment, the operation method of the electronic device 101 may include identifying, based on the information on the at least one cell, whether an attach failure rate of a fourth cell satisfies a designated second barring condition. The operation method of the electronic device 101 may include transmitting at least a portion of a UE capability of the first electronic device 101 to the fourth cell by adjusting the at least a portion of the UE capability of the first electronic device 101, based on the attach failure rate of the fourth cell satisfying the second barring condition.

According to an embodiment, in a computer-readable storage medium storing at least one instruction, the at least one instruction, when executed by at least one processor 120, 212, 214, or 260 of the electronic device 101, may cause the electronic device 101 to perform at least one operation. The at least one operation may include receiving, from the server, information on at least one cell determined based on the information associated with the first cell. The at least one operation may include identifying, based on the information on the at least one cell, that an error associated with a size of a UE capability occurs in a second cell among the at least one cell. The at least one operation may include, based on the error, transmitting at least a portion of a UE capability of the electronic device 101 to the second cell by adjusting the at least a portion of the UE capability of the electronic device 101 in case that the electronic device 101 moves to the second cell.

According to an embodiment, the electronic device 101 may include at least one processor 120, 212, 214, or 260. The at least one processor 120, 212, 214, or 260 may be configured to transmit information associated with a first cell to a server. The at least one processor 120, 212, 214, or 260 may be configured to receive, from the server, information on at least one cell determined based on the information associated with the first cell. The at least one processor 120, 212, 214, or 260 may be configured to identify, based on the information on the at least one cell, whether an error occurs in a second cell among the at least one cell. The at least one processor 120, 212, 214, or 260 may be configured to, based on identifying that an error occurs in the second cell, transmit at least a portion of a UE capability of the electronic device 101 to the second cell by adjusting the at least a portion of the UE capability of the electronic device 101 in case that the electronic device 101 moves to the second cell. The at least one processor 120, 212, 214, or 260 may be configured to transmit, based on identifying that an error does not occur in the second cell, a UE capability pre-stored in the electronic device 101 to the second cell in case that the electronic device 101 moves to the second cell.

According to an embodiment, an operation method of the electronic device 101 may include transmitting information associated with a first cell to a server. The operation method of the electronic device 101 may include receiving, from the server, information on at least one cell determined based on the information associated with the first cell. The operation method of the electronic device 101 may include identifying, based on the information on the at least one cell, whether an error occurs in a second cell among the at least one cell. The operation method of the electronic device 101 may include, based on identifying that an error occurs in the second cell, transmitting at least a portion of a UE capability of the electronic device 101 to the second cell by adjusting the at least a portion of the UE capability of the electronic device 101, in case that the electronic device 101 moves to the second cell. The operation method of the electronic device 101 may include transmitting, based on identifying that an error does not occur in the second cell, a UE capability pre-stored in the electronic device 101 to the second cell in case that the electronic device 101 moves to the second cell.

According to an embodiment, in a computer-readable storage medium storing at least one instruction, the at least one instruction, when executed by at least one processor 120, 212, 214, or 260 of the electronic device 101, may cause the electronic device 101 to perform at least one operation. The at least one operation may include receiving, from the server, information on at least one cell determined based on the information associated with the first cell. The at least one operation may include identifying, based on the information on the at least one cell, whether an error occurs in a second cell among the at least one cell. The at least one operation may include, based on identifying that an error occurs in the second cell, transmitting at least a portion of a UE capability of the electronic device 101 to the second cell by adjusting the at least a portion of the UE capability of the electronic device 101, in case that the electronic device 101 moves to the second cell. The at least one operation may include transmitting, based on identifying that an error does not occur in the second cell, a UE capability pre-stored in the electronic device 101 to the second cell in case that the electronic device 101 moves to the second cell.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory, comprising one or more storage media, storing one or more computer programs; and
one or more processors communicatively coupled to the memory,
wherein the one or more computer programs include computer-executable instructions that, when executed by the one or more processors individually or collectively, cause the electronic device to:
identify an attach failure rate associated with a first cell,
identify whether the attach failure rate satisfies a designated first barring condition,
based on identifying that the attach failure rate satisfies the designated first barring condition, adjust a UE capability of the electronic device by decreasing the size of the UE capability of the electronic device, and
transmit, to a second cell, the adjusted UE capability of the electronic device.

2. The electronic device of claim 1, wherein the one or more computer programs further include computer-executable instructions that, when executed by the one or more processors individually or collectively, cause the electronic device to, as at least part of the transmitting the adjusted UE capability of the electronic device to the second cell, exclude at least a portion of a plurality of first frequencies for carrier aggregation (CA) configured for the electronic device, and/or exclude at least a portion of a plurality of second frequencies for dual connectivity (DC) configured for the electronic device.

3. The electronic device of claim 2, wherein the one or more computer programs further include computer-executable instructions that, when executed by the one or more processors individually or collectively, cause the electronic device to, as at least part of the excluding the at least a portion of the plurality of first frequencies for CA configured for the electronic device, and/or excluding the at least a portion of the plurality of second frequencies for DC configured for the electronic device, exclude at least one frequency that is not supported by the second cell, from among the plurality of first frequencies and/or the plurality of second frequencies.

4. The electronic device of claim 1, wherein the one or more computer programs further include computer-executable instructions that, when executed by the one or more processors individually or collectively, cause the electronic device to,
transmit, to a server, information associated with the first cell,
receive, from the server, information on at least one cell determined based on the information associated with the first cell, and
based on the information on the at least one cell received from the server, identify at least one frequency that is not supported by the second cell.

5. The electronic device of claim 1, wherein the one or more computer programs further include computer-executable instructions that, when executed by the one or more processors individually or collectively, cause the electronic device to, identify that an error associated with a size of a UE capability occurs in the second cell, based on identifying that a value of a field indicating whether an error associated with a size of a UE capability occurs, among information corresponding to the second cell or information corresponding to a Tracking Area Identity (TAI) including the second cell, is a first value indicating an error.

6. The electronic device of claim 4, wherein the one or more computer programs further include computer-executable instructions that, when executed by the one or more processors individually or collectively, cause the electronic device to:
based on the information on the at least one cell, identify whether information associated with a call drop of the first cell satisfies a designated first change condition, and
based on the information associated with the call drop of the first cell satisfying the designated first change condition, perform at least one operation for changing a cell.

7. The electronic device of claim 4, wherein the one or more computer programs further include computer-executable instructions that, when executed by the one or more processors individually or collectively, cause the electronic device to:
based on the information on the at least one cell, identify whether information associated with a radio link failure (RLF) of the first cell satisfies a designated second change condition, and
based on the information associated with the RLF of the first cell satisfying the designated second change condition, perform at least one operation for changing a cell.

8. The electronic device of claim 4, wherein the one or more computer programs further include computer-executable instructions that, when executed by the one or more processors individually or collectively, cause the electronic device to:
based on the information on the at least one cell, identify whether a Voice over Internet Protocol (VOIP) failure rate and/or IMS registration failure rate of a third cell satisfies a designated second barring condition, and
based on the VOIP failure rate and/or IMS registration failure rate of the third cell satisfying the designated second barring condition, bar the third cell.

9. The electronic device of claim 8, wherein the one or more computer programs further include computer-executable instructions that, when executed by the one or more processors individually or collectively, cause the electronic device to, based on an elapse of designated time after barring the third cell, release barring the third cell.

10. The electronic device of claim 1, wherein the one or more computer programs further include computer-executable instructions that, when executed by the one or more processors individually or collectively, cause the electronic device to, in case that the electronic device moves to the second cell, transmit, to the second cell, the adjusted UE capability of the electronic device.

11. A method performed by an electronic device, the method comprising:
identifying an attach failure rate associated with a first cell;
identifying whether the attach failure rate satisfies a designated first barring condition;
based on identifying that the attach failure rate satisfies the designated first barring condition, adjusting a UE capability of the electronic device by decreasing the size of the UE capability of the electronic device; and
transmitting, to a second cell, the adjusted UE capability of the electronic device.

12. The method of claim 11, wherein the transmitting the adjusted UE capability of the electronic device to the second cell (comprises excluding at least a portion of a plurality of first frequencies for carrier aggregation (CA) configured for the electronic device, and/or excluding at least a portion of a plurality of second frequencies for dual connectivity (DC) configured for the electronic device.

13. The method of claim 12, wherein the excluding of the at least a portion of the plurality of first frequencies for CA configured for the electronic device, and/or excluding the at least a portion of the plurality of second frequencies for DC configured for the electronic device comprises excluding at least one frequency that is not supported by the second cell, from among the plurality of first frequencies and/or the plurality of second frequencies.

14. The method of claim 11, further comprising:
transmitting, to a server, information associated with the first cell,
receiving, from the server, information on at least one cell determined based on the information associated with the first cell, and
based on the information on the at least one cell received from the server, identifying at least one frequency that is not supported by the second cell.

15. The method of claim 11, further comprising:
identifying that an error associated with a size of a UE capability occurs in the second cell, based on identifying that a value of a field indicating whether an error associated with a size of a UE capability occurs, among information corresponding to the second cell or information corresponding to a Tracking Area Identity (TAI) including the second cell, is a first value indicating an error.

16. The method of claim 14, further comprising:
based on the information on the at least one cell, identifying whether information associated with a radio link failure (RLF) of the first cell satisfies a designated change condition; and
based on the information associated with the RLF of the first cell satisfying the designated change condition, performing at least one operation for changing a cell.

17. The method of claim 14, further comprising:
based on the information on the at least one cell, identifying whether a Voice over Internet Protocol (VOIP) failure rate and/or IMS registration failure rate of a third cell satisfies a designated second barring condition; and
based on the VOIP failure rate and/or IMS registration failure rate of the third cell satisfying the designated second barring condition, barring the third cell.

18. An electronic device, comprising:
memory, comprising one or more storage media, storing one or more computer programs; and
one or more processors communicatively coupled to the memory,
wherein the one or more computer programs include computer-executable instructions that, when executed by the one or more processors individually or collectively, cause the electronic device to:
transmit, to a server, information associated with a first cell,
receive, from the server, information on at least one cell determined based on the information associated with the first cell,
based on the information on the at least one cell, identify whether an error occurs in a second cell among the at least one cell,
based on identifying that an error occurs in the second cell, transmit, to the second cell, at least a portion of a UE capability of the electronic device by adjusting the at least a portion of a UE capability of the electronic device in case that the electronic device moves to the second cell, and
based on identifying that an error does not occur in the second cell, transmit, to the second cell, a UE capability pre-stored in the electronic device in case that the electronic device moves to the second cell.

19. One or more non-transitory computer-readable storage media storing one or more computer programs including computer-executable instructions that, when executed by one or more processors of an electronic device individually or collectively, cause the electronic device to perform operations, the operations comprising:
identifying an attach failure rate associated with a first cell;
identifying whether the attach failure rate satisfies a designated first barring condition;
based on identifying that the attach failure rate satisfies the designated first barring condition, adjusting a UE capability of the electronic device by decreasing the size of the UE capability of the electronic device; and
transmitting, to a second cell, the adjusted UE capability of the electronic device.

20. The one or more non-transitory computer-readable storage media of claim 19, the operations further comprising:
excluding at least a portion of a plurality of first frequencies for carrier aggregation (CA) configured for the electronic device, and/or excluding at least a portion of a plurality of second frequencies for dual connectivity (DC) configured for the electronic device.
